(19) United States
(12) Patent Application Publication
(10) Pub. No.: US 2007/0234037 A1
(43) Pub. Date: Oct. 4, 2007

(54) Information storage device

(75) Inventor: Seiji Toda, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/507,255

(22) Filed: Aug. 21, 2006

(30) Foreign Application Priority Data
Mar. 30, 2006 (JP) 2006-096043

(51) Int. Cl. H04L 9/00

(52) U.S. Cl. 713/155

(57) ABSTRACT

This encryption magnetic disk device can use a user password and a manufacture password as access restriction passwords. An encoding processing unit can encrypt user data, and a decoding processing unit can decrypt the encrypted user data. When its lock is canceled by a user password, the encryption magnetic disk device outputs the user data in a plain text. When its lock is canceled by a manufacturer password, the encryption magnetic disk device encrypts and outputs user data.

### BACKGROUND OF THE INVENTION

1. Field of the Invention

The present invention relates to an information storage device, such as a magnetic disk device and the like, and more particularly relates to an information storage device for encoding and outputting data stored in an information storage device to except permitted users.

2. Description of the Related Art

In today's information society, a personal computer (PC) is indispensable for an enterprise, a government office and the like, and also is widely spread among general homes. A magnetic disk device is used as a storage device for the PC in the built-in or externally attached form. A magnetic disk built in the magnetic disk device is superior to other storage media, such as a magneto-optical disk (MO), CD, DVD and the like, in the respects of storage capacity and access speed.

Conventionally, the magnetic disk device is generally provided with a security function. This security function uses a password, and the reading/writing of data stored in the magnetic disk device can be restricted by the password. Even its manufacturer cannot read/write data from/into a magnetic disk device in which a user sets a password (for example, see “Prior Art Technology” of Japanese Patent Application Publication No. 2004-201038).

When requested to inspect/repair a magnetic disk device in which a failure occurs, the manufacturer must inspect it to specify the cause of the failure. In order to specify the failure cause of the magnetic disk device, the manufacturer reads data by inputting a command (regular method), analyzes the device, and measures its electric signal and the like.

However, if a user sets a password in a magnetic disk device, data stored in the magnetic disk device cannot be read/written by the regular method, it is necessary for the user to teach his password.

A method for encoding data to be stored in a magnetic disk device in order to protect the security of data stored in the magnetic disk device is also known. This encoding is applied using software or hardware installed in its computer before storing data in the magnetic disk device (for example see Japanese Patent Application Publication Nos. 2002-319230 and H11-352881). Most of the current encoding of commercialized magnetic disk devices is applied to the entire magnetic disk.

As described above, when a password is set in a magnetic disk device, data cannot read/written from/into the magnetic disk device by the regular method unless the password is canceled. Therefore, if the user forgets its password, the magnetic disk device cannot be inspected by the regular method.

If a password is notified to its manufacturer when data stored in the magnetic disk device is not encrypted, the contents of data stored in a magnetic disk device is known to the manufacturer, which is a problem in the respect of data security protection.

### SUMMARY OF THE INVENTION

It is an object of the present invention to provide an information storage device capable of protecting the security of user data even when the inspection/repair of its failure is requested to its manufacturer.

The information storage device of the present invention presumes the capability of restricting access to stored data by setting a password.

The first aspect of the information storage device of the present invention comprises a manufacturer password storage unit, a user password storage unit, a user password registration unit and a user data output unit.

The manufacturer password storage unit stores manufacturer passwords. The user password storage unit stores user passwords. The user password registration unit records an inputted user password in the user password storage unit. The user password output unit user data stored in a record medium in the form of an encrypted sentence when an inputted password coincides with the manufacturer password recorded in the manufacturer password storage unit, and outputs the user data stored in the record medium in the form of a plain text when the password recorded in the user password storage unit is inputted.

In the first aspect of the information storage device, for example, the manufacturer password, the user password and the encryption key are recorded in the respective specific areas of the record medium.

According to the first aspect of the information storage device of the present invention, when the inspection/repair of an information storage device is requested to its manufacturer, the manufacturer can cancel the lock of the information storage device, by the setting of a user password and read data from the information storage device. In this case, since user data to be read from the information storage device is encrypted, the manufacturer cannot know the contents of the user data. Thus, the security of user information can be protected.

The second aspect of the information storage device of the present invention further comprises an encryption key storage unit for storing encryption keys in addition to the information storage device in the first aspect. Then, when outputting the user data in a plain text, the user data output unit encrypts user data stored in the record medium using the encryption key recorded in the encryption key storage unit.

According to the second aspect of the information storage device of the present invention, the same function/effect as the first aspect of the information storage device can be obtained.

The third aspect of the information storage device of the present invention further comprises an encrypting record unit for encrypting user data using the encryption key recorded in the encryption key storage unit and recording it on the record medium in addition to the information storage device in the second aspect.

According to the third aspect of the information storage device of the present invention, user data can be encrypted and stored in addition to the function/effect of the first aspect of the information storage device.

The fourth aspect of the information storage device of the present invention further comprises an encrypting record unit for encrypting user data using a first encoding key and recording it on a storage medium in addition to the information storage device in the first aspect. Then, the user data output unit encrypts the user data using a second encoding key and generates the cryptogram.

In the information storage device in the fourth aspect, for example, the first encryption key and the second encryption key are the same. The first and second encryption keys can also be both recorded in the record medium.

According to the fourth aspect of the information storage device of the present invention, the same function/effect as the first aspect of the information storage device, and also in its function, an encryption key used to encrypt and store user data and an encryption key used to encrypt and output user data can be used for their purposes.

The fifth aspect of the information storage device of the present invention further comprises an encryption key storage unit for storing encryption key in addition to the information storage device in the first aspect. Then, the user data output unit comprises an encrypting processing unit for encrypting user data stored in a record medium, using an encrypting key read from the encryption key storage unit and a decrypting processing unit for decrypting the encrypted user data stored in the record medium into a plain text.

According to the fifth aspect of the information storage device of the present invention, the same function/effect as the first aspect of the information storage device of the present invention can be obtained and also the same encryption key can be used to decrypt the encrypted user data into a plain text and to encrypt plain user data.

The sixth aspect of the information storage device of the present invention further comprises an encrypting record unit for encrypting user data using an encryption key recorded in the encryption key storage unit and storing it on the record medium in addition to the information storage device in the fifth aspect.

According to the information storage device in the sixth aspect of the present invention, the same function/effect as the fifth information storage device can be obtained and also user data can be encrypted and stored on a storage medium. Therefore, the security of user data stored in the record medium can be protected.

In the seventh aspect of the information storage device of the present invention, the manufacturer password is registered in a database possessed by a manufacturer manufacturing the information storage device in the information storage device in the first aspect.

According to the seventh aspect of the information storage device of the present invention, the same function/effect as the first aspect of the information storage device can be obtained and also its manufacturer can collectively manage manufacturer passwords by which encrypted user data can be read from the information storage device.

The information storage device of the present invention has a lock function to restrict access to data stored in it by setting a password, register a user password as the setting/cancel password of the lock function and register a manufacturer password as a password for canceling the lock function. Then, if a registered user password is inputted, it outputs user data in a plain text. If a registered manufacturer password is inputted, it encrypts and outputs the user data. Therefore, its manufacturer can read the user data stored in the information storage device whose inspection/repair is requested only in a cryptogram, thereby cannot know information about a user stored in the information storage device. Thus, even when a user requests a manufacturer to inspect and repair its information storage device, the security of user information stored in the information storage device can be protected. Even when a manufacturer password is illegally obtained by a third party other than its manufacturer, the third party cannot read user data stored in the information storage device only in the form of a cryptogram. Therefore, the security of user information stored in the information storage device can be protected.

### BRIEF DESCRIPTION OF THE DRAWINGS

FIG. 1 typically shows the basic operating principle of the magnetic disk device of the present invention in the case where data stored in a user using area is encrypted.

FIG. 2 typically shows the basic operating principle of the magnetic disk device of the present invention in the case where data stored in a user using area is plain text.

FIG. 3 shows the process from the manufacture/shipment of the encryption magnetic disk device, which is the preferred embodiment of the present invention, to the inspection/repair of its failure.

FIG. 4 shows the system configuration of a computer used by the user shown in FIG. 3.

FIG. 5 shows the hardware configuration of the encryption magnetic disk device shown in FIG. 4.

FIG. 6 shows the format of a magnetic disk built in the encryption magnetic disk device shown in FIG. 5.

FIG. 7 shows the configuration of the main part of the information processing unit of the present invention provided on the manufacturer side.

FIG. 8 shows an example of the structure of the manufacturer password DB shown in FIG. 7.

FIG. 9 is a flowchart showing the procedure until a manufacturer ships an encryption magnetic disk device after manufacturing it.

FIG. 10 is a flowchart showing the process procedure of the user of the encryption magnetic disk device of the preferred embodiment registering its user password in the encryption magnetic disk device.

FIG. 11 is a flowchart showing the process procedure of a user using the encryption magnetic disk device of the preferred embodiment.

FIG. 12 is a flowchart showing process procedure of a manufacturer inspecting and repairing a magnetic disk device when requested by a user.

FIG. 13 is a flowchart showing the password registration process of the encryption magnetic disk device of this preferred embodiment.

FIG. 14 is a flowchart showing the procedure of the access receiving process after the password registration of the encryption magnetic disk device of this preferred embodiment.

### DESCRIPTION OF THE PREFERRED EMBODIMENTS

The preferred embodiments of the present invention are described below with reference to the drawings.

### Principle of the Present Invention

### {Operation in the Case where the Data in the User using Area is Encrypted}

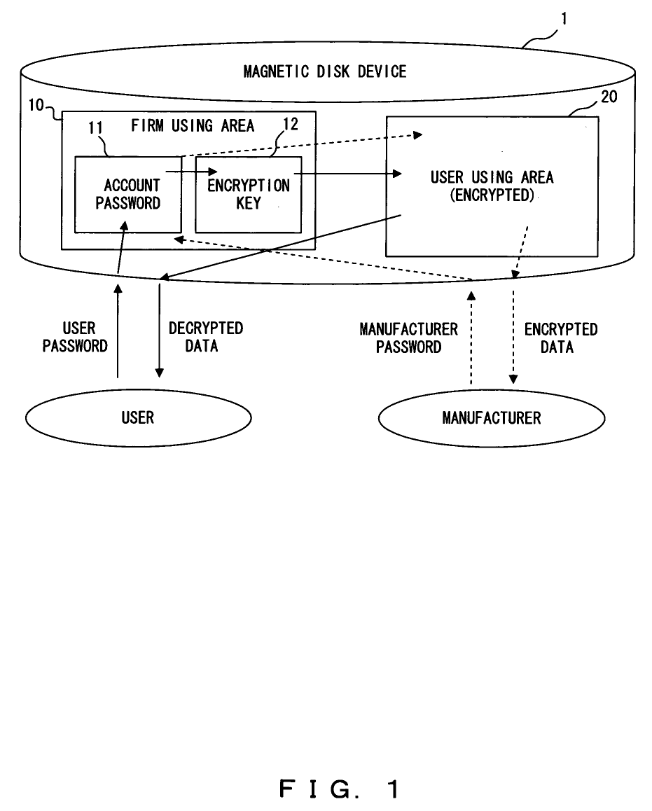

FIG. 1 typically shows the basic operating principle of the magnetic disk device of the present invention in the case where data stored in a user using area is encrypted.

The magnetic disk device 1 is provided with a firmware using area (firm using area) 10 and a user using area 20.

In the firm using area 10, an account password 11 and an encryption key 12 are recorded.

The account password 11 includes two types of a password for a manufacturer account (manufacturer password) and a password for a user account (user password). The manufacturer password is a password for manufacturer authentication. The manufacturer password is set/registered by a manufacturer when the magnetic disk device 1 is manufactured. The user password is a password for user authentication. The user password is set/registered by a user that has purchased the magnetic disk device 1. If the magnetic disk device 1 is shared by a plurality of users, the user password of each user is recorded in the firm using area 10. The encryption key 12 is set when a manufacturer manufactures the magnetic disk device 1 and is used to encrypt and decrypt data to be stored in the user using area 20.

The user using area 20 stores data of users. Data is stored in the user using area 20 as encrypted data (cryptogram) or non-encrypted data (plain text).

When there is an access request from a user, user authentication is performed by collating a user password inputted by the user with a user password stored in the firm using area 10. If the authentication succeeds, the data stored in the user using area 20 is outputted to the user. If there is an access request from a manufacturer, manufacturer authentication is performed by collating a manufacturer password inputted by the manufacturer with a manufacturer password stored in the firm using area 10. If the authentication succeeds, the data stored in the user using area 20 is outputted to the manufacturer.

If there is an access request from a user when data stored in the user using area 20 is cryptogram, the cryptogram is decrypted by the encryption key 12 and the decrypted data (plain text) is outputted. However, if there is an access request from a manufacture, the cryptogram is outputted without being decrypted. In the present invention, only user data stored in the user using area 20 can also be encrypted instead of the entire magnetic disk.

As described above, if data stored in the user using area 20 is encrypted when there is an access request from a user or a manufacturer, the magnetic disk device 1 of the present invention, the encrypted data is decrypted into a plain text and outputted to the user. However, the encrypted data is outputted to the manufacturer without being decrypted.

### {Operation in the Case where Data in the User using Area is Plain}

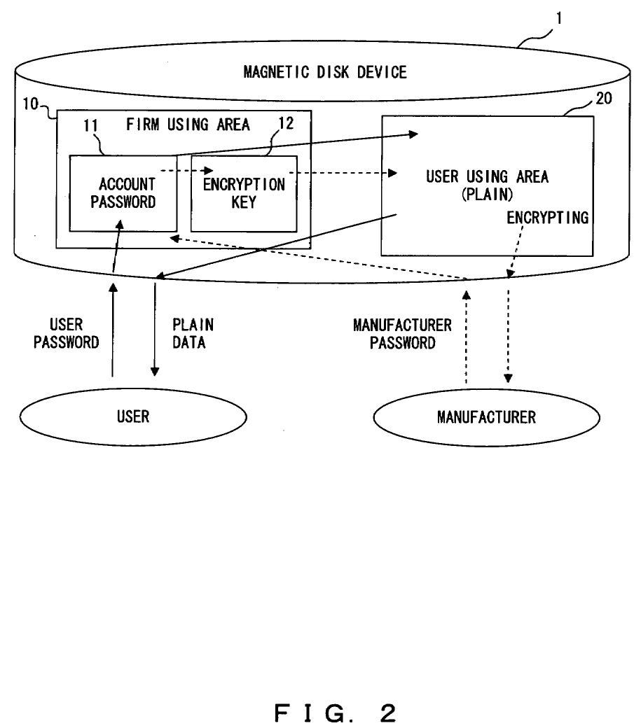

FIG. 2 typically shows the basic operating principle of the magnetic disk device of the present invention in the case where data stored in a user using area is plain text. In FIG. 2, the same reference numerals are attached to the same components as in FIG. 1.

If there is an access request from a user or a manufacturer even when data stored in the user using area 20 is plain text, as in described with reference FIG. 1, user authentication and manufacturer authentication are performed and the stored data is outputted to the user and the manufacturer.

In this case, although the plain text stored in the user using area 20 is outputted to the user, to the manufacturer, the plain text stored in the user using area 20 is encrypted using the encryption key 12 stored in the firm using area 10 and the encrypted data is outputted.

Thus, if data stored in the user using area 20 is plain text when there is an access request from a user or a manufacturer in the magnetic disk device 1 of the present invention, although the plain text is outputted to the user, to the manufacturer, the plain text is encrypted by the encryption key 12 and the encrypted data is outputted.

As described above, if there is an access request for data stored in the user using area 20 from a user or a manufacturer, regardless of whether the stored data is cryptogram or plain text, encrypted data is outputted to the manufacturer. To the user, plain data is outputted.

When a manufacturer is requested from a user to inspect/repair the magnetic disk device 1, the manufacturer reads the data in the user using area 20 (encrypted data) of the magnetic disk device 1, using a manufacturer password. Then, the manufacturer checks whether the signal of data stored in the magnetic disk device 1 is conformed to the specification, whether data in a specific area of the magnetic disk device is lost or some other faults exist, based on the encrypted data. Thus, the manufacturer can perform inspection needed to detect the failure cause of the magnetic disk device 1, using the encrypted data stored in the magnetic disk device.

In this inspection, since the manufacturer cannot read the data stored in the user using area 20 of the magnetic disk device 1 in the form of a plain text, the manufacturer cannot know the contents of information stored in the user using area 20 of the magnetic disk device 1. Thus, the user can protect the security of information stored in the user using area 20 of the magnetic disk device 1. Even when a third party illegally obtains a manufacturer password, the third party can read only encrypted data from the user using area 20 of the magnetic disk device 1. Therefore, the security of the contents of information stored in the magnetic disk device 1 by a user can be protected.

### Preferred Embodiments of the Present Invention

### [Configuration]

### {Used Form}

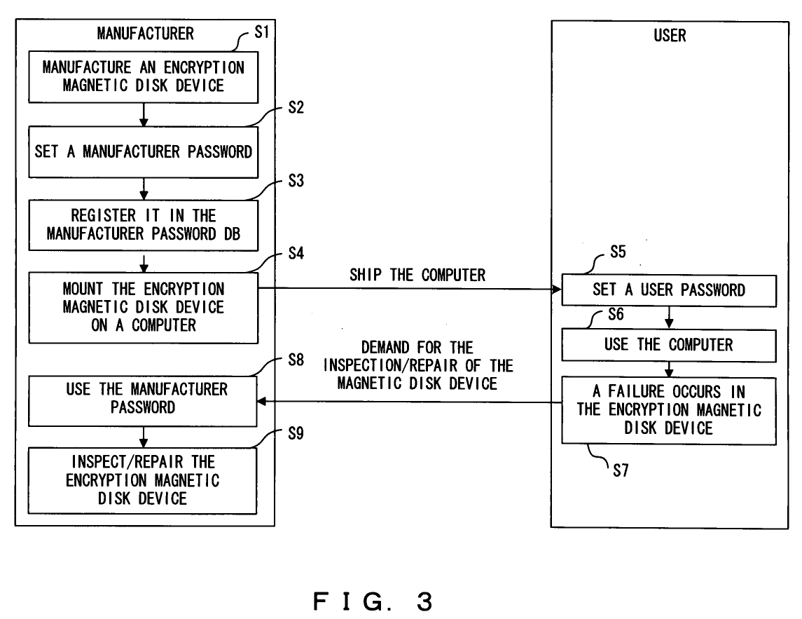

FIG. 3 shows the process from the manufacture/shipment of the encryption magnetic disk device, which is the preferred embodiment of the present invention, to the inspection/repair of its failure. This encryption magnetic disk device has the same function as the magnetic disk devices 1 shown in FIGS. 1 and 2.

When manufacturing an encryption magnetic disk device (S1), a manufacturer sets a manufacturer password (S2), and registers the manufacturer password in the manufacturer password database (manufacturer password DB)(S3). The structure of this manufacturer password DB is described later.

Then, the manufacturer mounts the encryption magnetic disk device on a computer (information processing unit, such as a personal computer, etc.) (S4) and ships it to the market.

A user that has purchased the computer provided with the encryption magnetic disk device sets a user password in the magnetic disk device (S5), and uses it (S6). When a failure occurs in the encryption magnetic disk device while using the computer (S7), the user requests the purchase source manufacturer to inspect/repair the encryption magnetic disk device.

Upon receipt of the request, the manufacturer reads the data of the encryption magnetic disk device using the manufacturer password and the like (S8) and inspects/repairs the encryption magnetic disk device (S9).

### {User Computer}

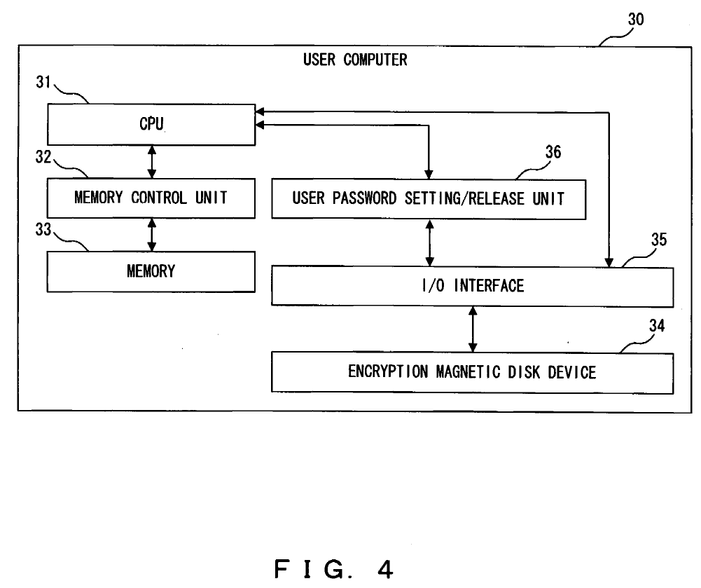

FIG. 4 shows the system configuration of a computer used by the user shown in FIG. 3.

The computer 30 shown in FIG. 4 comprises a CPU 31, memory 32, a memory control unit 33, an encryption magnetic disk device 34, an I/O interface 35 and a user password setting/cancel unit 36.

The CPU 31 executes an OS (operating system), an application program and the like, stored in the memory 33 to control the entire computer 30 and to perform various job processes. The memory 33 is semiconductor memory, such as ROM, RAM or the like. The memory control unit 32 reads/writes data from/into the memory 33, according to a control instruction from the CPU 31.

The encryption magnetic disk device 34 has the same function as the magnetic disk device 1 described with reference to FIGS. 1 and 2, and a user password can be set/canceled in/from the encryption magnetic disk device 34. The detailed configuration of this encryption magnetic disk device 34 is described later.

The I/O interface 35 interfaces the CPU 31 with the encryption magnetic disk device 34 and other peripheral devices, which are not shown in FIG. 4, and transmits/receives data to/from various peripheral devices including the encryption magnetic disk device 34, according to a command received from the CPU 31.

The user password setting/cancel unit 36 transmits prescribed commands to the encryption magnetic disk device 34 via the I/O interface 35 and controls to set/cancel a user password in/from the encryption magnetic disk device 34.

### {Hardware Configuration of the Encryption Magnetic Disk Device}

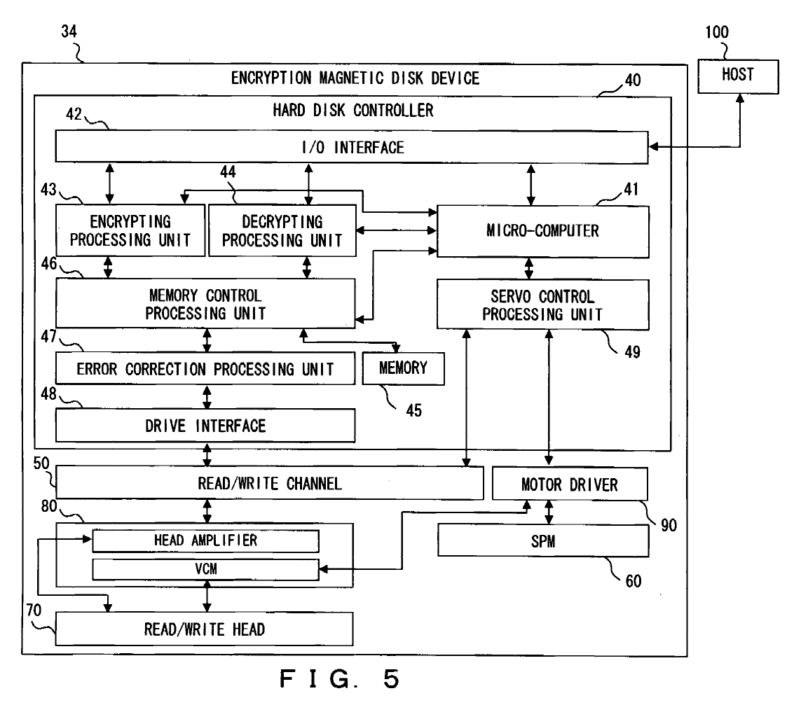

FIG. 5 shows the hardware configuration of the encryption magnetic disk device 34 shown in FIG. 4. In FIG. 5, the magnetic disk is omitted.

The encryption magnetic disk device 34 comprises a hard disk controller (HDC) 40, a read/write channel 50, a spindle motor (SPM) 60, a read/write head 70, a head amplifier/voice coil motor (VCM) 80, a motor driver 90.

The hard disk controller 40 comprises a micro-computer 41, an I/O interface 42, an encoding processing unit 43, a decoding processing unit 44, memory 45, a memory control processing unit 46, an error correction processing unit 47 and a drive interface 48.

The micro-computer 41 controls the entire hard disk controller 40 and also controls the I/O interface 42, the encoding processing unit 43, the decoding processing unit 44, the memory control processing unit 46 and a servo processing control unit 49.

The I/O interface 42 is a host interface transmitting/receiving commands and data with a host (computer, etc.) 100, based on a specification, such as ATA, SCSI and the like.

The encoding processing unit 43 encrypts data inputted from the I/O interface 42, using an encryption key received from the CPU 41 and outputs the encrypted data to the memory control processing unit 46. The decoding processing unit 43 decrypts the encrypted data inputted from the memory control processing unit 46, using a encryption key received from the CPU 41 and outputs the obtained plain text to the I/O interface 42.

The memory 45 is used as the read/write data buffer of the magnetic disk device 1.

The memory control processing unit 46 inputs/outputs data between the encoding processing unit 43, decoding processing unit 44, the error correction processing unit 47 and the CPU 41, and also controls a data transfer rate with the host 100, using the memory 45. The memory control processing unit 46 transmits/receives a plain text to/from the CPU 41. The memory control processing unit 46 also receives encrypted data from the encoding processing unit 43, and outputs a plain text inputted from the error correction processing unit 47 to the encoding processing unit 43. The memory control processing unit 46 also outputs encrypted data inputted from the error correction processing unit 47 to the decoding processing unit 44.

The error correction processing unit 47 adds an error correction code (ECC) to data inputted from the memory control processing unit 46 and outputs it to the drive interface 48. The error correction processing unit 47 also corrects the error of data inputted from the drive interface 48 and outputs the processed data to the memory control processing unit 46.

The read/write channel 50 modulates data to be written into the magnetic disk and outputs it to the head amplifier of the head amplifier/voice coil motor (VCM) 80. The read/write channel 50 also detects data from a signal inputted from the head amplifier and demodulates its code. The read/write channel 50 also obtains position information for positioning the read/write head 70.

The spindle motor 60 rotates the magnetic disk of the magnetic disk device 1. The read/write head 70 performs recording/reproducing of data for the magnetic disk of the magnetic disk device 1 by a magnetic recording method.

The head amplifier/voice coil motor (VCM) 80 has a write amplifier for recording data into the magnetic disk device 1 and a read driver for reproducing data read from the magnetic disk device 1 built-in. The head amplifier/voice coil motor (VCM) 80 also has a voice coil motor for moving the read/write head 70 built-in. The motor driver 90 controls to drive the spindle motor 60 and the voice coil motor 80.

The host 100 is an information processing unit which is provided with a host interface, such as ATA, SCSI or the like, and uses the encryption magnetic disk device 34 as an auxiliary storage device. The host interface of the host 100 is connected to the I/O interface 35 of the encryption magnetic disk device 34 by a cable or the like. The host 100 is provided with a function to set/cancel a user password to/from the encryption magnetic disk device 34 and a function to encrypt data and store it in the encryption magnetic disk device 34.

### {Recording Format of the Magnetic Disk of the Encryption Magnetic Disk Device 34}

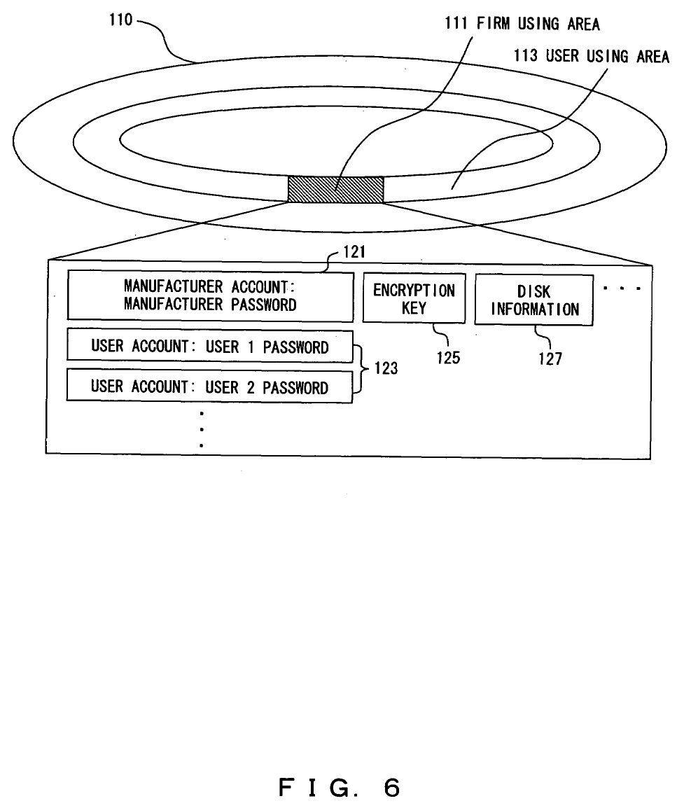

FIG. 6 shows the format of a magnetic disk built in the encryption magnetic disk device 34 shown in FIG. 5.

A firm using area 111 is provided in a prescribed truck of the magnetic disk 110.

The firm using area 111 stores one manufacturer password 121 and one or more user passwords (user 1 password, user 2 password,) 123. The firm using area 111 further stores an encryption key 125 and disk information 127.

The encryption key 125 is used as to encrypt/decrypt data stored in the user using area 113. For example, it is DES or AES. The disk information 127 is management information about the magnetic disk 110, such as the model name, serial number, number of cylinders and the like.

### {Information Processing Device on the Manufacturer Side}

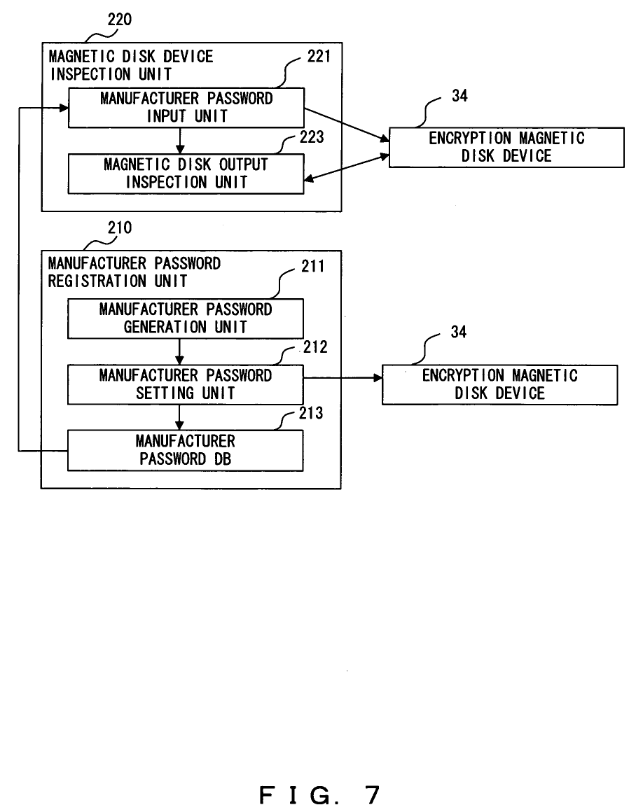

FIG. 7 shows the configuration of the major part of the information processing device of the present invention provided on the manufacturer side.

The information processing device on the manufacturer side comprises a manufacturer password registration unit 210 and a magnetic disk device inspection unit 220.

### <Manufacturer Password Registration Unit>

The manufacturer password registration unit 210 comprises a manufacturer password generation unit 211, a manufacturer password setting unit 212 and a manufacturer password DB 213. The manufacturer password registration unit 210 generates a manufacturer password and registers the manufacturer password in the encryption magnetic disk device 34 or the manufacturer password database (manufacturer password DB) 213.

The manufacturer password generation unit 211 generates a manufacturer password to be recorded in the firm using area 111 of the encryption magnetic disk device 34. This manufacturer password can be, for example, individual to each encryption magnetic disk device 34. Alternatively, it can be individual to each model of the encryption magnetic disk device 34. Since a individual device number (serial number) is assigned to the encryption magnetic disk device 34 when it is manufactured, each encryption magnetic disk device 34 can be identified by this serial number.

The manufacturer password setting unit 212 inputs the manufacturer password generated by the manufacturer password generation unit 211 and writes it in the firm using area 111 of the encryption magnetic disk device 34. Simultaneously, the manufacturer password setting unit 212 registers it in the manufacturer password DB 213.

The manufacturer password DB 213 manages manufacturer passwords recorded in the encryption magnetic disk device 34.

### <Magnetic Disk Device Inspection Unit>

The magnetic disk device inspection unit 220 comprises a manufacturer password input unit 221 and a magnetic disk output inspection unit 222. The magnetic disk device inspection unit 220 inspects the encryption magnetic disk device 34, for the inspection/repair of which a user has requested.

The manufacturer password input unit 221 inputs a manufacturer password obtained by retrieving data from the manufacturer password DB 213, based on the model name, serial number or the like of the encryption magnetic disk device 34 to inspect to the encryption magnetic disk device 34.

When the manufacturer password is inputted, the encryption magnetic disk device 34 encrypts and outputs data in the user using area.

When receiving a notice of inputting a manufacturer password, from the manufacturer password input unit 221, the magnetic disk output inspection unit 222 accesses the encryption magnetic disk device 34. Then, the magnetic disk output inspection unit 222 reads data from the encryption magnetic disk device 34 and detects the failure cause of the encryption magnetic disk device 34. In this case, data stored in the user using area 113 of the encryption magnetic disk device 34 is encrypted and outputted.

### {Manufacturer Password DB}

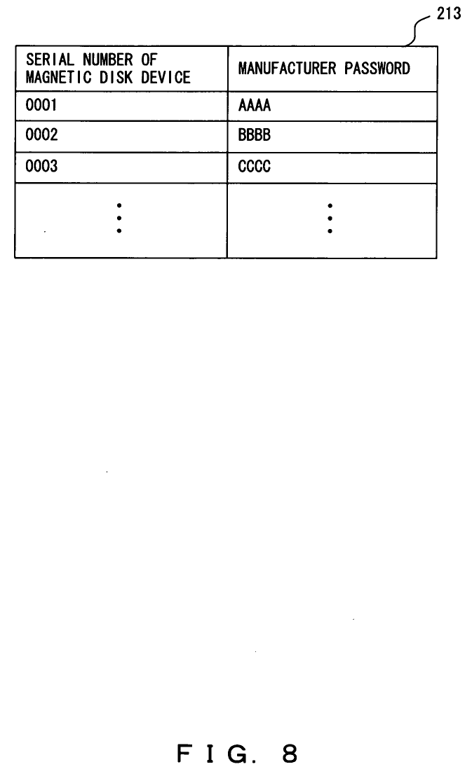

FIG. 8 shows an example of the structure of the manufacturer password DB 213 shown in FIG. 7.

Each line of the manufacturer password DB 213 stores the “serial number of a magnetic disk device (encryption magnetic disk device 34)” and the “manufacturer password of the magnetic disk device”. When the inspection/repair of the encryption magnetic disk device 34 is requested to a manufacturer, the manufacturer retrieves data from the manufacturer password DB 213, based on the serial number of the encryption magnetic disk device 34 and obtains the manufacturer password of the encryption magnetic disk device 34.

The manufacturer password DB 213 shown in FIG. 8 corresponds to a preferred embodiment in which a manufacturer password is assigned to each encryption magnetic disk device 34. If a manufacturer password is assigned to each model of the encryption magnetic disk device 34, the manufacturer password DB 213 stores the “serial number of the model of the encryption magnetic disk device 34” and the “manufacturer password of the encryption magnetic disk device 34”.

### [Operation]

The operation of the preferred embodiment with the above-described configuration is described below.

### {Manufacture/Shipment of the Encryption Magnetic Disk Device}

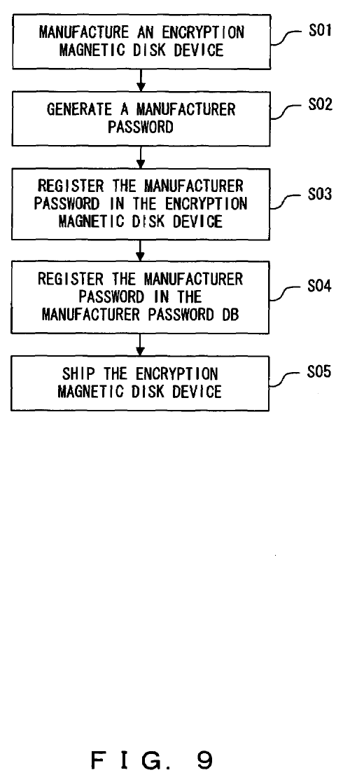

FIG. 9 is a flowchart showing the procedure until a manufacturer ships the encryption magnetic disk device 34 after manufacturing it.

A manufacturer manufactures the encryption magnetic disk device 34 (S01). Then, the manufacturer generates the manufacturer password of the encryption magnetic disk device 34 (S02), and registers the manufacturer password in the encryption magnetic disk device 34 (S03). Then, the manufacturer registers the manufacturer password in the manufacturer password DB 213 (S04), and ships the encryption magnetic disk device 34 the registration of whose manufacturer password is completed (S05).

### {Registration of a User Password}

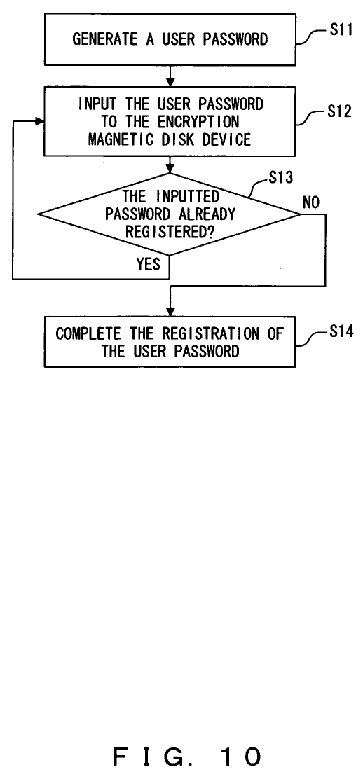

FIG. 10 is a flowchart showing the process procedure of the user of the encryption magnetic disk device 34 of the preferred embodiment registering its user password in the encryption magnetic disk device 34.

A user generates a user password (S11), and inputs the user password to the encryption magnetic disk device 34 (S12) The encryption magnetic disk device 34 determines whether the inputted user password coincides with a password (manufacturer or user password) already registered in the firm using area 111 of the encryption magnetic disk device 34 (S13). If it is the already registered password, the flow returns to step S12.

If in step S12 the inputted user password is not registered in the encryption magnetic disk device 34 yet, the user password is registered in the firm using area 111 of the encryption magnetic disk device 34 (S14).

### {User's Use of the Encryption Magnetic Disk Device}

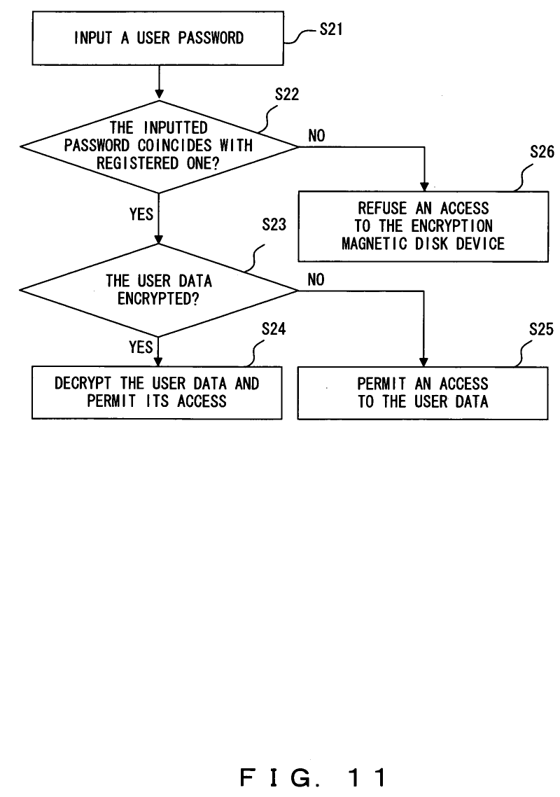

FIG. 11 is a flowchart showing the process procedure of a user using the encryption magnetic disk device 34 of this preferred embodiment.

When using the encryption magnetic disk device 34, the user firstly inputs a user password (S21). The encryption magnetic disk device 34 determines whether the inputted user password coincides with a user password registered in the firm using area 111 (S22). If they coincide with each other, the flow proceeds to step S23. If they do not coincide with each other, its access to the encryption magnetic disk device 34 is refused (S26).

In step S23, data accessed in the user using area 113 (user data) is read, and it is determined that the user data is encrypted (S23). If it is encrypted, the decoding processing unit 44 decrypts the user data, and an access to the decrypted data (plain text) is permitted (S24).

If in step S23 it is determined that the user data is not encrypted, an access to the user data (plain text) is permitted (S25).

Thus, the user can read the desired user data from the encryption magnetic disk device 34 in the form of a plain text by inputting a correct user password to the encryption magnetic disk device 34.

### {Inspection/Repair of the Encryption Magnetic Disk Device by a Manufacturer}

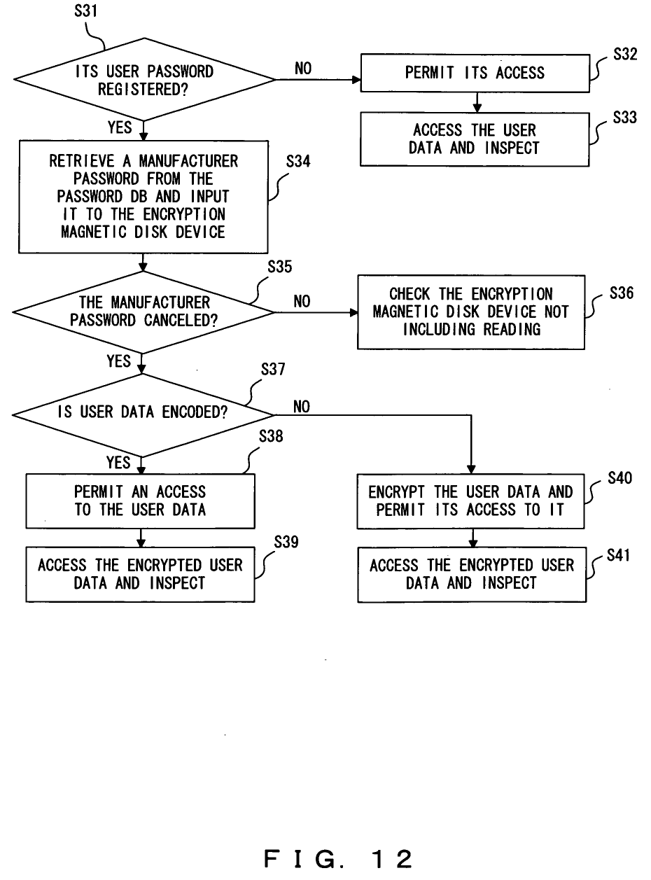

FIG. 12 is a flowchart showing the process procedure of a manufacturer inspecting and repairing a magnetic disk device, using the magnetic disk device inspection unit 220 when requested by a user.

A manufacturer firstly determines whether a user password is registered in the magnetic disk device (S31). The process in step S31 is performed for starting the magnetic disk device and checking whether the magnetic disk device is locked by a password. If it is password-locked, it is determined that its user password is registered in the magnetic disk device. If it is determined that its user password is not registered, an access to the magnetic disk device is not restricted and permitted (S32). In this case, the magnetic disk output inspection unit 222 accesses the encryption magnetic disk device 34 to read data from the encryption magnetic disk device 34 and inspects the encryption magnetic disk device 34, based on the data (S33).

If in step S31 it is determined that its user password is registered, the manufacturer determines that the magnetic disk device is the encryption magnetic disk device 34. Then, the manufacturer retrieves the manufacturer password of the encryption magnetic disk device 34 from the manufacturer password DB 213 and inputs the obtained manufacturer password to the encryption magnetic disk device 34 from the manufacturer password input unit 221 (S34). Then, it is determined whether the manufacturer password of the encryption magnetic disk device 34 is canceled (S35). If the manufacturer password is not canceled, the flow proceeds to step S36. If it is canceled, the flow proceeds to step S37.

In step S36, inspection not including data reading is applied to the encryption magnetic disk device 34.

In step S37, the encryption magnetic disk device 34 determines whether the data (user data) of the user using area 113 is encrypted. If it is encrypted, the flow proceeds to step S38. If it is not encrypted, the flow proceeds to step S40.

In step S38, the encryption magnetic disk device 34 permits the magnetic disk output inspection unit 222 to access user data. When being permitted to access to encryption magnetic disk device 34, the magnetic disk output inspection unit 222 reads the user data from the user using area 113 of the encryption magnetic disk device 34 and inspects the encryption magnetic disk device 34, based on the user data (S39).

In step S40, the encryption magnetic disk device 34 encrypts the user data stored in the user using area 113 by the encoding processing unit 43. When the encoding of the user data is completed, the encryption magnetic disk device 34 permits the magnetic disk output inspection unit 222 to access the encryption magnetic disk device 34 (S40). When its access to the encryption magnetic disk device 34 is permitted, the magnetic disk output inspection unit 222 accesses the user using area 113 of the encryption magnetic disk device 34 to read the encrypted data of data (plain) stored in the user using area 113 and inspects the encryption magnetic disk device 34, based on the encrypted data S41).

Thus, the manufacturer can cancel the password lock of the encryption magnetic disk device 34 by inputting the legal manufacturer password to the encryption magnetic disk device 34 via the manufacturer password input unit 221. Then, after the cancel of the password lock of the encryption magnetic disk device 34, the manufacturer can read the encrypted user data from the user using area 113 of the encryption magnetic disk device 34, using the magnetic disk output inspection unit 222 and inspect the encryption magnetic disk device 34.

### {Operation of the Encryption Magnetic Disk Device}

### <Operation at the Time of Password Registration>

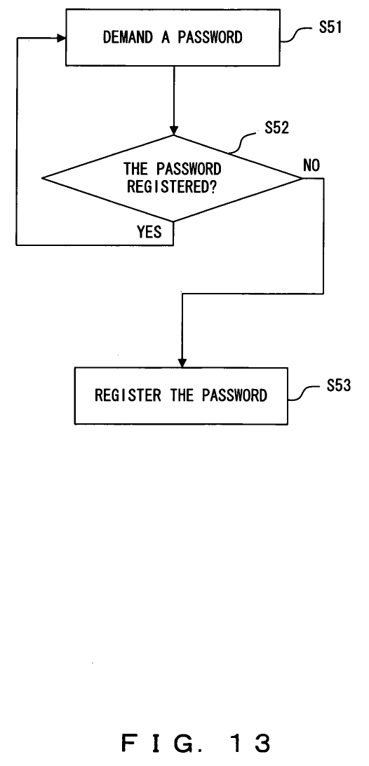

FIG. 13 is a flowchart showing the password registration process of the encryption magnetic disk device 34 of this preferred embodiment. The process in this flowchart is common to the case of registering a manufacturer password and the case of registering a user password.

The encryption magnetic disk device 34 demands input of a password (S51). When a password is inputted, it is determined whether the password is already registered (S52). If the inputted password is already registered, the flow returns to step S51. If it is not registered, the inputted password is registered in the firm using area 111 of the encryption magnetic disk device 34 (S53).

### 1. Registration of a Manufacturer Password

When registering a manufacture password, there should be no registered password in the encryption magnetic disk device 34 at the time of password registration. However, in preparation for an emergency, in step S52 it is determined that the inputted password is not registered yet by checking whether there is a registered password and whether there is no registered password that coincides with the inputted password. If the inputted password coincides with any registered password, the registration of the inputted password is refused.

Since a manufacturer registers a different password at an individual encryption magnetic disk device 34, the following process must be performed in advance.

If an inputted password is already registered in another encryption magnetic disk device 34 when retrieving data from the manufacturer password DB 213, it is determined that the password is already registered. If an inputted password is not registered in any encryption magnetic disk device 34 yet, it is determined that the password is not registered yet.

If a manufacturer password is assigned to each model of the encryption magnetic disk device 34, the determination process by a manufacturer is as follows.

It is determined whether an inputted password coincides with a password assigned to another model of the encryption magnetic disk device 34 by retrieving data from the manufacturer password DB 213. If they coincide with each other, the inputted password is not registered. If the inputted password coincides with that of the same model of the encryption magnetic disk device 34, the inputted password is registered.

Thus, a correct manufacturer password can be registered in the encryption magnetic disk device 34.

### 2. Registration of a User Password

When registering a user password, registered manufacturer and user passwords are read from the firm using area 111 of the encryption magnetic disk device 34. If an inputted password coincides with any of such passwords, it is determined that the inputted password is already registered. If an inputted password does not coincide with any of such passwords, it is determined that the inputted password is not registered yet.

### <Operation of the Encryption Magnetic Disk Device After the Registration of a User Password>.

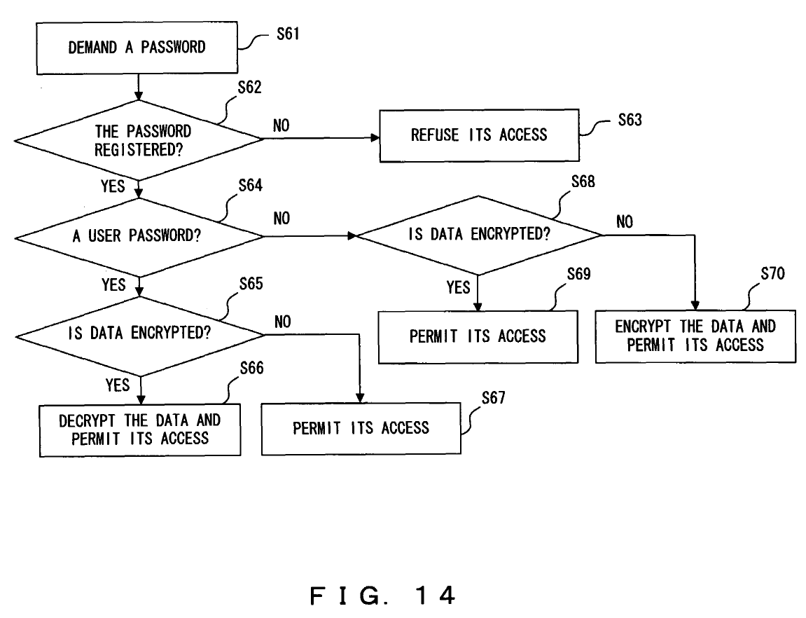

FIG. 14 is a flowchart showing the procedure of the access receiving process after the password registration of the encryption magnetic disk device of this preferred embodiment.

The encryption magnetic disk device 34 demands the input of a password (S61). When a password is inputted, the encryption magnetic disk device 34 reads a password (manufacturer or user password) registered in the firm using area 111 and determines whether the inputted password coincide with the registered password (S62). If they do not coincide with each other, in other words, when the inputted password is not registered, its access is refused (S63).

If in step S62 it is determined that the inputted password is registered, it is determined whether the inputted password is a user password (S64). If it is a user password, the flow proceeds to step S65. If it is a manufacturer password, the flow proceeds to step S68.

In step S65, data is read from the user using area 113 and it is determined whether the data is encrypted. If it is encrypted, the read data is decrypted and its access to the decrypted data (plain text) is permitted (S66). If it is not encrypted, its access to the read data (plain) is permitted (S67).

In step S68, data is read from the user using area 113 and it is determined whether the data is encrypted. If it is encrypted, its access to the decrypted data (encrypted text) is permitted (S69). If it is not encrypted, the read data is encrypted and its access to the encrypted data (cryptogram) is permitted (S70).

Thus, if an inputted password is a user password, the encryption magnetic disk device 34 outputs data stored in the user using area 113 in a plain text. If an inputted password is a manufacturer password, the encryption magnetic disk device 34 outputs data stored in the user encryption magnetic disk device 34 in a cryptogram.

As described above, the encryption magnetic disk device 34 of the present invention can register two passwords; a user password used by a user and a manufacturer password used by a manufacturer, in order to lock the encryption magnetic disk device 34. The manufacturer password is generated when manufacturing the encryption magnetic disk device 34 and is recorded in the encryption magnetic disk device 34. A manufacturer manages this manufacturer password and stores it in the manufacturer password DB 213.

The lock of the encryption magnetic disk device 34 can be canceled by inputting a registered user or manufacturer password. If the lock is canceled by inputting a user password, the encryption magnetic disk device 34 outputs user data in a plain text even when the user data is stored in either form of an encrypted or plain text. If user data is encrypted when the lock is canceled by a manufacturer password, the encryption magnetic disk device 34 outputs the user data without performing any process. If it is not encrypted, the encryption magnetic disk device 34 outputs the user data after encrypting it.

When a user requests its manufacturer to inspect/repair the encryption magnetic disk device 34, the manufacturer cancels the lock of the encryption magnetic disk device 34 by obtaining the manufacturer password of the encryption magnetic disk device 34 from the manufacturer password DB 213 and inputting it to the encryption magnetic disk device 34 and reads its user data. However, since this user data is encrypted, the manufacturer cannot know the contents of the user data. Thus, the security of user data is protected. Since the manufacturer cans cancels the encryption magnetic disk device 34 locked by a user password by inputting its manufacturer password, there is no need for a user requesting for the inspection/repair of the encryption magnetic disk device 34 to teach the manufacturer its user password. Therefore, even when a user forgets its user password, a manufacturer can inspect/repair the encryption magnetic disk device 34.

Although in the above-described preferred embodiment, both manufacturer and user passwords are recorded in the magnetic disk; these passwords can also be stored in a storage medium other than the magnetic disk provided in the magnetic disk device. These passwords can also be stored in separate storage media.

Although in the above-described preferred embodiment, an encryption key is recorded in the firm using area 111 of the magnetic disk 110, the storage form of an encryption key is not limited to this. For example, the encryption key can also be stored in a storage medium other than the magnetic disk provided in the magnetic disk device. Furthermore, the encryption key can also be stored in an external storage medium, such as USB memory or the like, and can also the magnetic disk device encrypt/decrypt user data by inputting the encryption key from the external storage device.

Although in the above-described preferred embodiment, Encrypting/decrypting processing is executed by hardware processing, it is allowed that the processing is executed software processing.

Although in the above-described preferred embodiment, the same encryption key is used to encrypt user data recorded in the magnetic disk and to encrypt plain user data read from the magnetic disk when a manufacturer password is inputted, separate encryption keys can also be used for the two pieces of encrypting.

Although the magnetic disk device in the above-described preferred embodiment is provided with a function to encrypt user data and to record it in a magnetic disk, the magnetic disk of the present invention is also applicable to a magnetic disk device not provided with a function to encrypt user data.

Although in the above-described preferred embodiment, the encryption magnetic disk device is built in a computer, the encryption magnetic disk device of the present invention is not limited to a built-in type, and is also applicable to an externally attached type connected by a USB (universal serial bus) or the like. The electronic device in which the magnetic disk of the present invention is built is not limited to a computer, and it can also be a PDA (personal data assistant), a cellular phone, a portable music player or the like.

What is claimed is:

1. An information storage device capable of restricting an access to recorded data by setting a password, comprising:
a manufacturer password storage unit for storing manufacturer passwords;
a user password storage unit for storing user passwords;
a user password registration unit for recording inputted user passwords in the user password storage unit; and
a user data output unit for outputting user data recorded in a record medium in a cryptogram when an inputted password coincides with a manufacturer password stored in the manufacturer password storage unit and outputting user data recorded in the record medium in a plain text when an inputted password is recorded in the user password storage unit.

2. The information storage device according to claim 1, wherein
the manufacturer password storage unit and user password storage unit are provided in the same storage medium.

3. The information storage device according to claim 2, wherein
the storage medium in claim 2 is the record medium as in claim 1.

4. The information storage device according to claim 1, wherein
the manufacturer password storage unit and user password storage unit are provided in separate storage media.

5. The information storage device according to claim 1, wherein
the encryption key is recorded in the record medium.

6. The information storage device according to claim 1, wherein
the manufacturing password, the user password and the encryption key are recorded in a specific area of the record medium.

7. The information storage device according to claim 6, wherein
the specific area is area for recording firmware of the record medium.

8. The information storage device according to claim 1, further comprising
an encryption key storage unit for storing encryption key,
wherein
when outputting the user data in a cryptogram, the user data output unit encrypts the user data recorded in the record medium, using an encryption key stored in the encryption key storage unit.

9. The information storage device according to claim 8, further comprising
an encrypting record unit for encrypting user data, using an encryption key stored in the encryption key storage unit and recording it in the record medium.

10. The information storage device according to claim 1, further comprising
an encrypting record unit for encrypting user data, using a first encryption key,
wherein
the user data output unit encrypts the user data using a second encryption key to generate the cryptogram

11. The information storage device according to claim 10, wherein
the first and second encryption keys are the same.

12. The information storage device according to claim 11, wherein
both the first and second encryption keys are recorded in the record medium.

13. The information storage device according to claim 1, further comprising
an encryption key storage unit for storing encryption key,
wherein
the user data output unit comprises
an encrypting processing unit for encrypting user data stored in a storage medium, using an encryption key read from the encryption key storage unit; and
a decrypting processing unit for decrypting encrypted user data stored in a storage medium into a plain text, using an encryption key read from the encryption key storage unit.

14. The information storage device according to claim 13, further comprising
an encrypting record unit for encrypting user data using an encryption key stored in the encryption key storage unit and recording it in the record unit.

15. The information storage device according to claim 1, wherein
the user data outputting unit comprises
an encrypting processing unit for encrypting user data recorded in the record medium, using an encryption key externally inputted; and
a decrypting processing unit for decrypting encrypted user data recorded in a record medium into a plain text, using the encryption key.

16. The information storage device according to claim 15, further comprising
an encrypting record unit for encrypting user data, using an encryption key stored in the encryption key storage unit and recording it in the record medium.

17. The information storage device according to claim 1, further comprising
a manufacturer password recording unit for recording a manufacturer password in the record medium.

18. The information storage device according to claim 1, wherein
the manufacturer password is registered in a database possessed by a manufacturer manufacturing the information storage device.

19. The information storage device according to claim 18, wherein
each manufacturer password is related to each information storage device and is managed in the database.

20. The information storage device according to claim 18, wherein
each manufacturer password is related to each model of an information storage device and is managed in the database.
